(19) United States
(12) Patent Application Publication
(10) Pub. No.: US 2024/0396744 A1
(43) Pub. Date: Nov. 28, 2024

(54) SYSTEM AND METHOD FOR INCREASED RESILIENCY OF MOBILE WIRELESS NETWORKS VIA DISTRIBUTED PUBLIC-KEY INFRASTRUCTURE (PKI) ALLIANCES

(71) Applicants: UNIVERSITY OF SOUTH FLORIDA, Tampa, FL (US); OREGON STATE UNIVERSITY, Corvallis, OR (US)

(72) Inventors: Bechir Hamdaoui, Tampa, FL (US); Attila Altay Yavuz, Tampa, FL (US)

(21) Appl. No.: 18/676,435

(22) Filed: May 28, 2024

Related U.S. Application Data
(60) Provisional application No. 63/504,643, filed on May 26, 2023.

(51) Int. Cl. H04L 9/32

(52) U.S. Cl. CPC H04L 9/3263; H04L 9/3247

(57) ABSTRACT

Systems, devices, and methods are disclosed herein that implement efficient frameworks for Public-Key Infrastructure (PKI) functions. In some implementations of such frameworks, a PKI alliance may comprise multiple, independent certification authorities (CAs), that can coordinate signing operations for digital certificates based on umbrella public keys that a device can use for authentication with any of the CAs. Some embodiments may use multi-party computational thresholding in such signing operations. In other aspects, a device may generate an umbrella public/private key pair, and obtain a digital certificate for the umbrella public key which can be used for efficient network handoffs among CAA members and other secure connections.

### CROSS REFERENCE TO RELATED APPLICATION

This application claims priority to U.S. Provisional Application No. 63/504,643, filed on May 26, 2023, which hereby is incorporated herein by reference in its entirety.

### TECHNICAL FIELD

The technology discussed below relates generally to network security, and more particularly, to the distribution and alliance of Certification Authorities and Public Key Infrastructure.

### INTRODUCTION

Current and next-generation (NextG) mobile networks are being developed and deployed with the primary aim to enable new features and services that go beyond conventional mobile broadband services. These mobile networks are tasked with providing and guaranteeing reliable and secure connectivity to everything, everywhere, and anytime through the support of a variety of network verticals (e.g., Connected Vehicles, Unmanned Aerial Systems, Industrial IoTs, and Networked Robots, just to name a few), each having different resiliency requirements. The end-users, radio access technologies, and applications that current and NextG mobile networks support are expected to increase dramatically in number and heterogeneity, paving the way for increased security threats and vulnerabilities of unprecedented types and scale. Therefore, the security aspects of NextG mobile networks must be considered with an open eye for such new vulnerabilities to produce secure and resilient network systems.

Network security protocols and standards are key components crucial to the resiliency, trustworthiness, and robustness of network systems. A critical weakness of existing network systems is their reliance on centralized Public Key Infrastructure (PKI), which makes them vulnerable to network entity/key-compromising attacks, single-point-of-failure, and scalability performance problems. In addition, the heavy overhead in computation, size, and communication due to emerging post-quantum (PQ)-safe practices put the design task of such mechanisms at another challenging level. Therefore, there is an urgent need for distributed, compromise-resilient infrastructures and techniques to ensure the robustness and resiliency of NextG mobile networks.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the present disclosure provides for methods by which mobile devices may connect to multiple networks, such as in a network handoff. (It should be recognized, however, that such methods may also be utilized for establishing multiple other connections, not merely in the context of a network handoff). Such methods may comprise establishing a secure connection between a mobile device and a first network, so that the mobile device may communicate via the first network operated by a first network provider. In establishing such connection, the mobile device may be authenticated with the first network using an umbrella public key. The mobile device may then identify a second network operated by a second network provider, different from the first network provider, and present itself for authentication to the second network using the same umbrella public key. Upon establishing secure connection with the second network, the mobile device may then communicate via the second network.

The present disclosure also provides for devices that may perform methods such as the foregoing methods. For example, in one aspect, a device is provided comprising: a wireless transceiver configured to communicate with at least one class of wireless network; a processor connected to the wireless transceiver; and a memory having software stored thereon which, when executed by the processor, causes the processor to: establish secure connection with a first wireless network by requesting a digital certificate using an umbrella public key; communicate via the first wireless network; determine that a secure connection to a second wireless network, different from the first wireless network, should be made; authenticate connection with the second wireless network using the same umbrella public key; and communicate via the second wireless network.

The present disclosure also provides systems and methods for coordinating signing and verification operations in support of a mobile device using an umbrella public key. For example, in one aspect, the disclosure provides a method for authenticating a device on a network, which may entail the first time a device connects to such network or an instance in which a device needs to be re-authenticated with such network. Such a method may comprise the steps of: receiving a signal at a first certificate authority, the signal containing information regarding the device and being associated with a public key; determining that the signal includes a request for a digital certificate; verifying an identity of the device; communicating information associated with the request to other certificate authorities, the first certificate authority and the other certificate authorities being members of a certificate authority alliance; generating a digital certificate for authenticating the device via the public key, in collaboration with at least a portion of the other certificate authorities through a threshold signature scheme; and transmitting the digital certificate to the device.

In other respects, the present disclosure provides for the foregoing method of authentication to be performed by network operators or other devices that utilize the first certificate authority for authentication and/or digital signature issuance.

In further respects, the present disclosure provides methods for authenticating a device via a second certificate authority that is also a member of the certificate authority alliance, without having to issue a new certificate. In such methods, members of the certificate authority alliance may collaborate to verify a digital signature to authenticate the device for the request sent to the second certificate authority.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flow chart illustrating an exemplary process for employing an umbrella public key to interact with multiple certification authorities.

FIG. 2 is a block diagram depicting a device utilizing an umbrella public key and its interactions with a CA of a CAA.

FIG. 3 is a flow chart illustrating an exemplary process for generating an umbrella public key in a distributed public-key infrastructure alliance system.

FIG. 4 is a diagram conceptually depicting different action flows for authentication of a vehicle as it traverses several networks.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and embodiments by illustration to some examples, those skilled in the art will understand that additional implementations and use cases may come about in many different arrangements and scenarios. Innovations described herein may be implemented across many differing platform types, devices, or systems. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments.

As used herein, the phrase “Public Key Infrastructure” (PKI) means a framework of hardware, software, policies, and procedures that can be used to create, manage, distribute, store, and revoke digital certificates and public-private key pairs. PKI enables secure communication and authentication over networks by employing asymmetric cryptography.

As used herein, the phrase “Certification Authority” (CA) means an entity that is responsible for issuing digital certificates.

As used herein, the phrase “digital certificate” means a document transmitted by a CA that verifies the identity of an entity or device in electronic communications.

As used herein, the phrase “registration authority” (RA) means an entity that can work with a CA to facilitate the issuance and management of digital certificates. RAs can verify the identity of digital certificate applicants prior to sending the information to a CA for certificate generation.

As used herein, the phrase “public key” means a type of cryptographic key that can be used in encryption algorithms for encrypting data or verifying digital signatures. A public key facilitates secure communication between entities and can be shared openly without compromising the security of a system.

As used herein, the phrase “private key” means a type of cryptographic key that can be used in in conjunction with a public key. Private keys decrypt data that has been encrypted with a corresponding public key. For example, private keys can be specific to a user/device, kept confidential, and/or securely stored by their owners to prevent unauthorized access and maintain the security of a cryptographic system.

As used herein, the phrase “Security Credential Management System” (SCMS) indicates a centralized platform or framework that can be used to manage security credentials such as digital certificates, cryptographic keys, and other authentication materials.

### Advantages of Embodiments Disclosed Herein

Wireless network verticals supported by current architectures and standards (e.g., 3GPP and IEEE 1609.2) rely on both pre-shared symmetric-key approaches (e.g., 4G's EPS-AKA and 5G's AKA/EAP-AKA′) and public-key approaches (e.g., WiFi's EAP-TLS and Connected Vehicles' SCMS/PKI) to enable network security services like device authentication, data encryption/integrity, and identity confidentiality. Standardization bodies and organizations, like ETSI/3GPP for cellular systems and IEEE/WAVE for connected vehicles, have adopted both symmetric and public key-based approaches as components of various NextG network architectures. However, these current approaches suffer from one or more of the following limitations:

(1) Compromise vulnerability (a security limitation). Current public-key infrastructure (PKI)-based mobile networks rely on centralized certification authority (CA) approaches. This makes such networks unnecessarily vulnerable to key breaches, as compromising that single CA entity can result in the entire system being compromised. Similarly, current symmetric-key approaches are also vulnerable to such compromises. An authentication server residing on the serving network (e.g., 5G core network [55]) must keep a secret key for each end user, and thus when such a server is comprised, then so are all end users. Physical compromises are also threats in some scenarios. For instance, IoT/sensor devices deployed in physically open and accessible environments (e.g., public buildings) are vulnerable to onsite key compromises. Therefore, new approaches that protect devices and servers against such compromises are sorely needed.

(2) Trust centralization (a security limitation). The key management and access control centralization (in both public and symmetric key settings) has the inherent feature of centralized trust. For instance, in a single-CA architecture, an end user wishing to authenticate with a serving network has no option but to trust this CA. Although a device might have some implicit trust in the service provider, offering security frameworks that distribute trust across different entities—whether belonging to the same service owner or not-makes such networks more trustworthy. As described in the present disclosure, distributed trust can also be a key enabler for network security standards and services (e.g., IEEE WAVE/SCMS, spectrum management) that benefit from the cooperation of various distinct industrial, governmental and national entities to function

(3) Complex mobility and handover (a performance limitation). Newly emerging mobile networks like autonomous vehicles are highly dynamic and, by nature, mobile. Thus, they are equipped with network devices being required to re-authenticate multiple times during the course of longer travel to keep up with their ongoing connections due to network handovers. Current PKI centralization, here again, stands as an obstacle to ensuring seamless device mobility, as PKI providers, each imposing its own certification management process, place an extra burden on mobile devices that might need to connect to multiple different providers during their ongoing communications. It is, therefore, important to develop roaming-friendly approaches that allow mobile devices to establish secure communication efficiently and fast with multiple different PKI providers on the go.

(4) Unreliability and lack of scalability(performance limitation). The current PKI centralization also gives rise to typical single-point-of-failure challenges, which translate into system reliability and traffic bottleneck issues. Similar problems also arise in symmetric-key approaches used for data aggregation applications like those enabled by the massive numbers of resource-limited IoT devices deployed, for instance, in cities to collect sensory data. The periodic collection and transfer of small-sized data with authentication tags can incur excessive traffic overhead without efficient and secure data aggregation techniques.

(5) Standards compliance (security limitation). Current cryptographic standards (e.g., NIST standards like AES/SHA/DSS are increasingly used for ensuring secure communication and private message exchange. Similarly, emerging NIST standards, like NIST's recently selected post-quantum cryptography (PQC) standards (June 2022) and lightweight cryptography (LWC) schemes (March 2021), could also be highly beneficial components of NextG networks due to their provable security and performance guarantees. Therefore, it is desirable that PKI frameworks be designed in compliance with emerging NIST standards to facilitate their incorporation and rapid adoption into real-system deployments. To date, they are not so-designed.

To address the security of concerns of NextG mobile networks, the concept of a Distributed PKI Alliance (PKI Alliance) Framework is introduced, that provides solutions to many of the issues faced by current systems. Such a framework that can be implemented in different ways, and used differently by different categories of entities involved in establishing secure communications. Some of the advantages of such a framework include that systems using the aspects described herein can (i) increase network resiliency to compromise and fault tolerance, (ii) enable distributed trust, and (iii) offer seamless PKI handoff. The PKI Alliance uses threshold cryptography to enable distinct and potentially competing PKI owners (e.g., Certificate Authorities (CA)) to form a partnership without disclosing the cryptographic secrets of their infrastructure.

In some aspects of the disclosure, a PKI Alliance can use Secure Multi-party Computation (MPC) and threshold digital signatures to permit generation of a certificate authenticating a device based on one or more “umbrella public keys” (upk), without exposing their individual private keys. The upks allow the members of a PKI Alliance to fulfill security operations by using the upk instead of processing certificate requests, authenticating devices, and generating digital certificates on a CA by CA basis. The use of upks can drastically reduce the cyber-security overhead of handover operations for mobile users. Moreover, the approaches discussed herein are inherently distributed, thereby addressing hurdles of central PKIs such as breaches or system failures.

The present disclosure sets forth various principles of a PKI Alliance comprising a number of CA members. In some examples, CAs serving different device types, networks, and/or geographic regions come together to form CA Alliances (CAAs), with each CAA being able to utilize a upk to authenticate a device, while its CA members maintain their own private keys. With this approach, a digital certificate issued by the CAA corresponding to a upk suffices for authentication and establishing secure communication with all members served by the alliance, and any other device wanting to verify a device's certificate is required to only know the upk. Optionally, a CAA can set a minimum number of CAs that belong to the CAA to cooperate together to issue these certificates on behalf of the CAA. Systems based upon such an approach can enable reduction of handoff overhead between CAs, increase network resiliency to CA compromises, enable fault tolerance, and enable distributed trust across multiple CAs.

It should be recognized that the frameworks described herein may apply equally to several types of cryptographic key-based communications. For example, frameworks in accordance with the present disclosure may utilize symmetric key encryption (SKE) as well as asymmetric key encryption (such as PKI methods). Rather than members of a CAA using MPC thresholding to perform certificate signing and verification operations, members of a Symmetric Key Alliance may generate symmetric keys and perform decryption methods for a given symmetric key through MPC thresholding. For example, a Symmetric Key Alliance could use an MPC threshold scheme to generate a symmetric key—a mobile device may have a copy of the symmetric key in full, while each member of the SKA may have only a share of the symmetric key so that no single party can misuse the symmetric key (or release a copy) without the others. Similarly, when a mobile device encrypts a message using the symmetric key, the SKA could require a threshold number of members to participate using their own key shares in order to accomplish decryption. And, in this scenario, the mobile device can seamlessly continue to use the same symmetric key for secure communication with any of the members of the SKA, and in a method largely invisible to the mobile device, the network operator that is communicating with the mobile device can decrypt the messages with the aid of a threshold number of members of the SKA and encrypt outgoing messages similarly. In this sense, the mobile device's symmetric key can be thought of as a type of umbrella cryptographic key—an ‘umbrella symmetric key’. This avoids several pitfalls of existing approaches, such as: (1) no one entity (other than the mobile device) has a full copy of the symmetric key, thus limiting the chances that a compromised network/device/entity can perform harmful communications using the key with the mobile device; and (2) the mobile device does not need to arrange for a new symmetric key for communication with each individual member of the SKA. Thus, the same advantages described herein with respect to PKI configurations (including the improvements and solutions over existing attempts) can also be largely achieved in an SKE regime. While a SKA framework may not have the same public verifiability and non-repudiation properties of a PKI alliance (e.g., for digital signatures), it can be used to provide authentication and integrity measures such as authenticated encryption (with NIST's ASCON as in NIST-LWC) and HMAC, in addition to encryption/decryption purposes. When compared to 1-1 symmetric key sharing between a mobile device and network/server, the non-repudiation property of SKA is considerably improved, because now not one but a set of servers must perform the authentication tag generation (albeit still not identical to the non-repudiation properties of a PKI alliance, as there is would be no public key in a SKA scheme). Finally, SKA can offer all the benefits of distributed access control and key management typical for threshold cryptographic services.

### Example Processes

The various frameworks described herein (including processes to be performed by users/mobile devices and to be performed by CAs/Alliances/network operators/etc.) provide efficient solutions to overcome the aforementioned drawbacks. Thus, in the context of the following general description, it should be recognized that a system employing these processes to implement a distributed cryptographic key framework can: (1) enable resilient and efficient cryptographic management of wireless networks in a way that is transparent to mobile devices/users (e.g., the framework will not incur additional computational overhead for the devices/users, nor require changes in the devices' hardware or fundamental capabilities); (2) enable seamless device mobility, portability, and efficient multi-connectivity, by providing incentives for competing mobile/wireless network operators and key management towners to form alliances that result in reducing mobility and handover operational overhead, yet while maintaining the secrecy of their private keys; and (3) provide for compliance with current and emerging security standards (such as NIST standards), thereby permitting secure-by-design PQ security for networks, including lightweight IoT security.

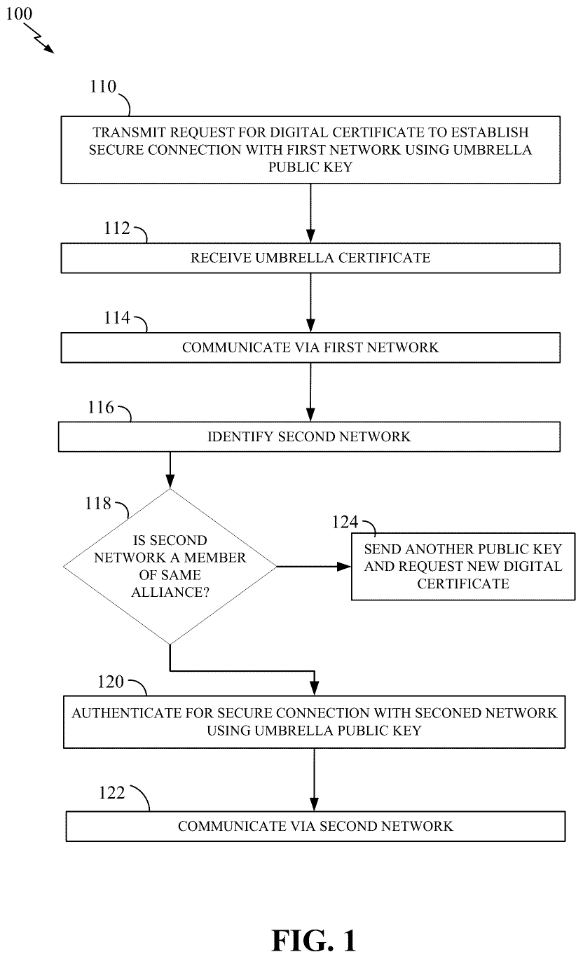

Referring now to FIG. 1, a flowchart is shown that conceptually illustrates a method 100 by which a device can establish secure/authenticated connections to two different networks, such as in the situation of a network handoff or other transition.

At block 110, the device may transmit a request to establish a connection to a first network, which may be required/requested to be a secure and/or authenticated connection. In some embodiments, a device may request to connect to a first network, which request may comprise (or be interpreted by the network as) a request for a digital certificate to establish a secure connection with the first network. The device running process 100 may include information relating to a public key in association with such request. The public key may be a upk that can be used to authenticate the device across several networks/CAs of a PKI Alliance. In other embodiments, the public key may be a different type of cryptographic key, such as a symmetric key.

At block 112, the device may receive a digital certificate corresponding to the public key that it associated with its request. In some embodiments, the digital certificate can be thought of as an “umbrella digital certificate,” given that it may be used to establish authenticated, secure connection with multiple different networks. From the perspective of the device running process 100, the particular method by which the digital certificate was generated can be visible or transparent—in other words, the device running process 100 need not know how the operator of the first network and/or the CA associated with the first network generated the umbrella digital certificate. In some embodiments, the umbrella digital certificate may be generated through a threshold signing operation conducted collaboratively by multiple members of the PKI Alliance.

At block 114, secure communication is established and the device running process 100 may communicate via the first network. For example, process 100 may entail a vehicle or automobile, or other ‘mobile’ device, connecting to a wireless network such as a mobile cellular network and engaging in packet transfer for data service. In other embodiments, process 100 may entail a mobile device (such as an autonomous drone or vehicle) connecting to another mobile device that it encounters, via a more local or private network, such as for communication of information to coordinate local movements and/or information regarding a local environment, etc.

At block 116, the device operating process 100 may identify a second network. For example, an automobile traveling on a lengthy trip may determine that it should connect to a second wireless network that has a higher signal strength than the connection to the first network. Thus, it may be that the first wireless network and second wireless network have distinct, overlapping, or otherwise different geographic service areas or coverage areas. As another example, an autonomous drone may encounter a leader drone, or a vehicle may encounter a local ‘smart city’ network as it is moving and determine that it must make a second connection to the leader drone or smart city network in addition to or instead of the connection to the first network.

Optionally, at block 118, process 100 may determine whether the second network is a member of the same PKI Alliance as the first network. In some embodiments, the second network may indicate during preliminary communications or handshake process whether it is a member of a given PKI Alliance, such as the PKI Alliance that generated the digital certificate for the device's upk or a different PKI Alliance (or no Alliance). In other embodiments, process 100 may make this determination 118 by attempting to send the upk and associated certificate to the second network to determine empirically if the second network can utilize the upk (e.g., per block 120)

If the second network is not a member of the same PKI Alliance as the first network, then process 100 may begin a new authentication process with the second network at block 124. For example, process 100 may send a new public key to the second network and request a digital certificate per current standard procedures and/or in accordance with blocks 110-114. In other examples, process 100 may determine that the second network belongs to a second PKI Alliance, which the device running process 100 has previously authenticated with, and thus may use a second umbrella public key/certificate that the device had stored in order to make connection with the second network.

At block 120, process 100 may begin making a secure, authenticated connection to the second network. The device operating process 100 may attempt to utilize the same upk and associated digital certificate that was used to establish connection with the first network. In some embodiments, process 100 may automatically attempt to use the last umbrella public key and associated certificate that was used to make a network connection (or another existing umbrella public key/certificate). In other embodiments, process 100 may only attempt to establish connection to the second network where it is known that the second network uses a CA that is part of the CA Alliance that issued the certificate associated with the existing upk. Where the CA for the second network is part of the same Alliance as the CA for the first network, then process 100 can authenticate for a secure connection with the second network using the upk. And, at block 122, process 100 may proceed to communication via the second network.

In should be noted that, even where the CA associated with the first network and the CA associated with the second network are part of the same alliance, each network operator may still retain its own private/public key used for authenticating itself to the device running process 100.

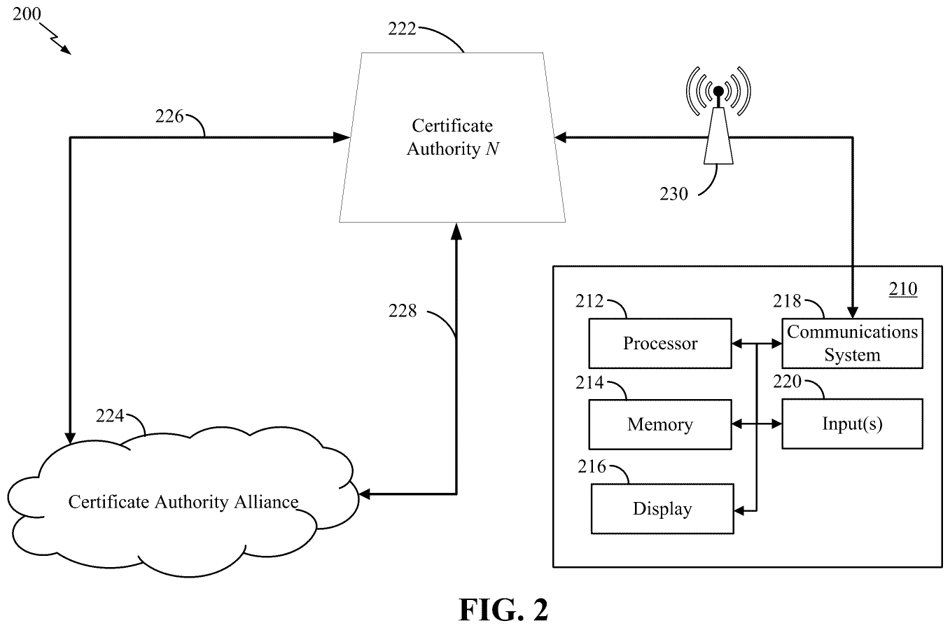

Referring now to FIG. 2, a block diagram is shown, illustrating an example of a device 210 that may perform process 100, as well as its interaction with a CA 222. It should be understood that FIG. 2 is a conceptual diagram only, and that other components of an overall implementation of a PKI Alliance Framework are possible but not shown (for example, a network operator, a registration authority, individual blocks for other CAs of the Alliance, etc.).

In some examples, device 210 can include a processor 212. In some embodiments, the processor 212 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc.

In further examples, computing device 210 can also include a memory 214. The memory 214 can include any suitable storage device or devices that can be used to store suitable data (e.g., copies of digital certificates, public/private key pairs, etc.) and instructions that can be used, for example, by the processor 212 to perform process 100 and communicate via a network in a secure fashion (e.g., network 230). The memory 214 can include any suitable volatile memory, non-volatile memory, storage, or any suitable combination thereof. For example, memory 214 can include random access memory (RAM), read-only memory (ROM), electronically-erasable programmable read-only memory (EEPROM), one or more flash drives, one or more hard disks, one or more solid state drives, one or more optical drives, etc. In some embodiments, the processor 212 can execute at least a portion of process 100 described above in connection with FIG. 1, and other computing resources may perform other portions of process 100 and/or subsidiary tasks (such as, e.g., generation of private/public key pairs, assessment of whether a network handoff should take place, generation of data or packets to be sent via network 230, etc.).

In further examples, computing device 210 can further include communications system 218, which may comprise a transceiver suitable for communication via the type of wireless network of a given network 230 for which process 100 may be performed. For example, the transceiver of communications system 218 may comprise a 5G capable antenna and transmitter, an 802.11 or other WiFi-capable transceiver, an LTE transceiver, a Bluetooth transceiver, or other wireless or wired network-capable transmitting/receiving equipment. Communications system 218 can include any suitable hardware, firmware, and/or software for communicating information over communication network 230 and/or any other suitable communication networks. For example, communications system 218 can include one or more transceivers, one or more communication chips and/or chip sets, etc. In a more particular example, communications system 218 can include hardware, firmware and/or software that can be used to establish a Wi-Fi connection, a Bluetooth connection, a cellular connection, an Ethernet connection, etc.

In some examples, the communication network 230 can be any suitable communication network or combination of communication networks. For example, the communication network 230 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 230 can be a local area network, a wide area network, a public network (e.g., the Internet), a private or semi-private network (e.g., a corporate or institutional intranet), any other suitable type of network, or any suitable combination of networks.

In further examples, computing device 210 can further include a display 216 and/or one or more inputs 220. In some embodiments, the display 216 can include any suitable display devices, such as a computer monitor, a touchscreen, a television, an infotainment screen, etc. that may present a user interface and/or display data obtained through secure connection with network 230. In further embodiments, the input(s) 220 can include any suitable input devices and/or sensors that can be used to receive user input, such as a keyboard, a mouse, a touchscreen, a microphone, etc.

As depicted, device 210 may connect to a network 230, but need not directly communicate with a CA 222 (though such connection is possible). In the configuration shown, the operator of network 230 may receive a upk from device 210, may verify the identity of device 210 (whether through its own systems, or by coordination with a separate RA), and then may instruct the network operator's CA 222 to issue a digital certificate to bind the upk to the identity of device 210. The digital certificate may be generated through multi-party threshold computational methods, as described herein, via coordination between the given CA 222 and other CAs of the PKI Alliance 224. In some embodiments, the coordination may involve a variety of functions, such as certificate generation 226, and certificate authentication or verification 228.

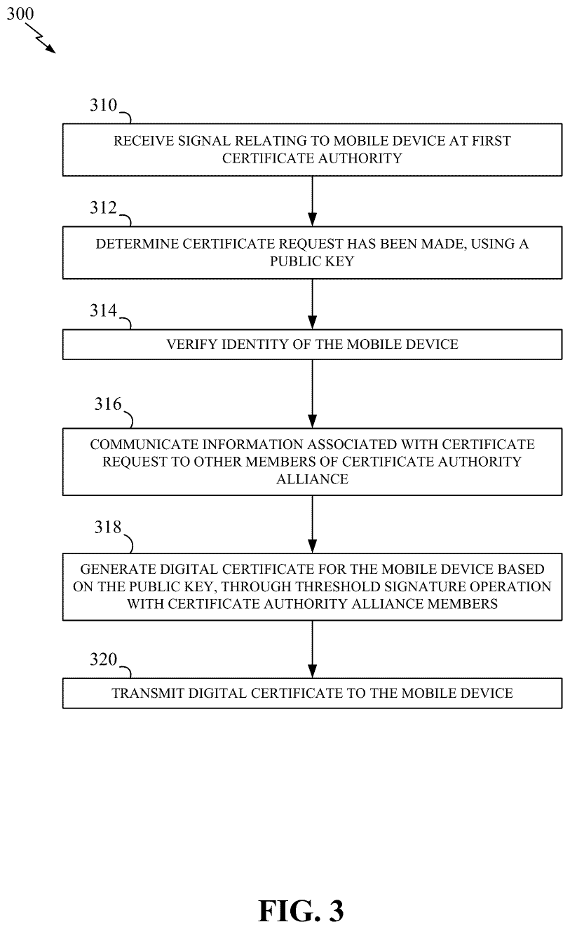

Referring now to FIG. 3, a conceptual flow diagram is shown, illustrating certain aspects of how a PKI Alliance Framework may be implemented from the perspective and functions of a given network operator or CA N (e.g., 222 in FIG. 2) of a CAA (e.g., 224 in FIG. 2) having T members. In process 300, a given CA may receive a signal relating to a device that needs to be authenticated in order to connect to a network (or to connect to another device, or other circumstance in which verification/authentication us used). For example, at block 310, the signal received by the CA may contain certain information about the device, the user of the device, and/or a public key. At block 312, process 300 determines that the device is making a certificate request or that a certificate is needed. For example, the signal may comprise a certificate signing request (CSR) as part of enrollment of the device in a mobile network or as part of granting certain permissions to a device for access to network resources.

In some embodiments, the signal received at block 312 may not necessarily have come from the device itself; for example it may have come from an intermediary such as a registration authority (RA) or a network operator and may have been modified to indicate that the device should be granted a digital certificate. Thus, the initial signal itself (from block 312) may already contain a verification of the device's identity.

In other embodiments, at block 314 the process 300 may verify the identity of the device for which the certificate will be issued. This may be performed via a separate communication with a company, a MNO, an RA, or other suitable entity.

At block 316, process 300 then communicates information associated with the certificate request to members of the CAA. If process 300 is being performed by an entity other than a CA member of the CAA (e.g., by a network operator), then the information may be communicated to a single CAA member, multiple CAA members, or all CAA members by such entity.

At block 318, the members of the CAA will then collaboratively generate a digital certificate to correspond to the public key of the device. Because all CAs of the CAA are involved in creating (i.e., “signing”) the certificate, the public key and signed certificate can be utilized as an umbrella public key/umbrella certificate as described herein. In some embodiments, the generation/signing of the certificate by the CAA may be done through a threshold process as described in the present disclosure.

At block 320, the digital certificate is then provided for the device. After issuing the digital certificate (which binds the identity of the device to the upk), the device can then be verified by any member of the CAA. For example, as the device moves geographically and connects to various independently-operated networks (or otherwise encounters other devices or resources to which it will connect), each CA of the CAA can authenticate the device using the existing umbrella public key/digital certificate for such networks or other devices/resources.

It should be understood that process 300 is adaptable for use with a non PKI-based cryptographic scheme as well, such as a SKE scheme. In such a scheme, rather than issue a certificate based on a device's umbrella public key, the alliance could instead utilize multi-party thresholded computation (or other distributed methods) to generate a symmetric key for the mobile device (or to distribute shares of a symmetric key provided by the mobile device among alliance members). Then, rather than perform authentication based on an issued certificate, the alliance could perform encryption and decryption of messages using the symmetric key, such as through MPC threshold-based encryption/decryption functions.

### Experiments and Example Embodiments

Certain example embodiments, and associated experiments and evaluations conducted by the inventors, will now be described. While various details and alternatives are discussed below, they are intended to supplement and support (and not limit the generality of) the other sections of the present disclosure, such as the descriptions of FIGS. 1-3 and the claims hereof.

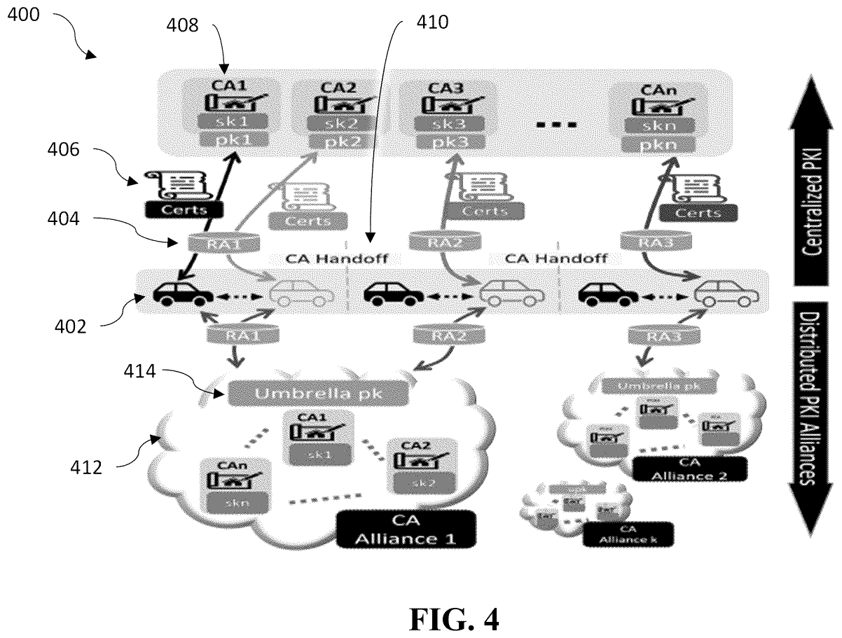

FIG. 4 is a diagram illustrating an exemplary process 400 for CA certificate acquisition and CA handoff that a vehicle 402 may perform on a journey. Vehicle 402 is equipped with an SCMS that enables the secure exchange of basic safety messages (BSMs) among connected vehicles. To ensure anonymity, the SCMS allows each vehicle device to obtain multiple pseudonyms (short-term) certificates 406, to be issued in batches by the pseudonym CAs 408 and sent to the device to attach, one at a time, to its BSMs for signature verification. In such a large system, there will naturally be numerous CAs 408 owned and operated by various governing entities. Different CAs 408 are assigned to different device groups that could, for instance, be formed based on device manufacturers, geographic regions, device types, etc. As the vehicle 402 travels, assume it utilizes a form of vehicular public key infrastructure interaction whereby it will eventually be in a position where it will be advantageous to exchange BSMs with devices whose certificates are issued by other CAs 408, resulting in multiple CA handoffs 410, each of which forces the vehicle to perform a series of security operations with these other CAs 408, including authentication and requesting new certificates 406. SCMS has many architectural entities but the vast majority of them, especially critical components like CAs 408, are functionally and cryptographically centralized.

The centralized nature of PKIs, such as in the case of SCMS described above, gives rise to a few major challenges: (i) High PKI compromise risks, as the compromise of a CA entity undermines the security of the entire system relying on it. (ii) Inherently centralized trust, as devices are required to trust their assigned CAs. (iii) Significant handoff overhead, resulting from frequent CA handoffs that occur every time the vehicle is required to communicate with a vehicle covered by other CAs, due to geographic region change, device type change, etc. This overhead (in delay, traffic, and computation) is proportional to the number of handoffs, as well as to the depth of the CA hierarchy/certificate chaining and is vastly aggravated further when considering post-quantum-safe cryptography and the large number of certificates that SCMS requires devices to obtain to ensure anonymity.

In one embodiment of the present disclosure, a PKI Alliance incorporates Secure Multi-Party Computation (MPC)-based Thresholding. MPC-based thresholding is a cryptographic technique that allows a group of entities to jointly perform cryptographic operations without any entity having to reveal its confidential information to the others. In threshold signature schemes, a digital signature is generated collaboratively by multiple parties, where each party holds a share of the private signing key. Exemplary cryptographic operations include key generation, encryption, decryption, and signing. To produce a signature, a subset of parties (equal to or greater than the threshold) cooperatively combine their shares using cryptographic protocols to compute the signature without revealing their individual shares or private key. The National Institute of Standards and Technology (NIST) advocates for thresholding, where multiple t-out-of-n entities must execute the cryptographic operations to achieve the required security, thus increasing the resiliency against a compromise and/or failure of up to t entities. A threshold can be applied to any cryptographic primitive, including the digital signatures that are used as the authentication basis for the PKI Alliance.

Flexible Round-Optimized Schnorr Threshold (FROST) is an exemplary cryptographic scheme that enhances the security and efficiency of threshold signatures. FROST is based on the Schnorr signature algorithm which is a method for creating and verifying digital signatures. The FROST scheme focuses on optimizing the round complexity of threshold signature generation, making it suitable for applications where low latency and efficiency are essential, such as real-time transaction processing in blockchain networks.

A PKI Alliance with MPC-based thresholding offers two benefits: (i) MPC-based thresholding only impacts the signing operation (and not other metrics like key size, verification, etc.), which greatly benefits NextG networks, as signature/public key sizes and certificate verification dominate their online cryptographic operations. (ii) MPC-based thresholding is seamless, meaning that network users do not need to know that signatures are threshold-based, which is so crucial to facilitating standardization adoption. MPC-threshold PKI Alliances can be achieved by utilizing, as non-limiting examples: FROST, NIST-PQC standards (e.g., Falcon), Dilithium), Schnorr signatures with MPC-based thresholding, or ECDSA-type signatures with MPC-based thresholding.

In another embodiment of the present disclosure, Custom Threshold Signatures can be used to enhance the security of a PKI Alliance. It is possible to utilize custom threshold signatures, which are specifically designed for distributed execution, but with a deviation from the base (single signer) signature. For example, FROST is a custom threshold signature that is based on Schnorr signatures. Similarly, there are custom lattice-based threshold signatures that offer postquantum security. Those custom lattice-based signatures are not NIST-PQC compliant but might offer more efficiency depending on the underlying lattice primitives. The PKI Alliance framework can also be instantiated by any of these building blocks.

In another embodiment of the present disclosure, the PKI Alliance leverages Identity-based Delegations to mitigate handover costs and enhance compromise resiliency. Identity-based delegations typically involve a first entity with authority granting permissions to a second entity (the delegate) on behalf of a third entity (the delegator). Delegated permissions can include, for example role assignment, accessibility, and administrative responsibility. Identity-based signatures (IBS) can eliminate certificates from the digital signature, thereby reducing network transmission costs. However, IBS requires a centralized (trusted) entity (Public Key Generator (PKG)) to produce private and public keys for every user to achieve this goal. Despite its bandwidth efficiency, the centralized trust requirement might be too risky for some NextG network applications. PKI Alliances are ideal for mitigating the hurdles of IBS centralization (and other certificateless signatures broadly) while still receiving the benefit from their bandwidth savings. PKI Alliances can utilize a threshold key generation scheme to create identity-based private/public keys without users having to disclose their private keys to any centralized PKI/CA entity. Not only does this mitigate the trust issues in IBS but also maintains the certificateless features. Specifically, the members of the PKI (or PKG) alliance form the root level of the threshold signature scheme with their master key shares at the setup phase. Identity-based Schnorr-type signatures are highly amenable to threshold execution (e.g., as in Schnorr-based FROST), and therefore are suitable for this purpose. The PKI/PKG Alliance then delegates an IBS signing key but with a certain validity time period (e.g., a week) to the Network Service Providers (NSP)s in their corresponding regions. These NSPs then serve as the PKI/PKG that can issue valid IDs acting as the public key for mobile users. This ID remains valid only for a designated time period, and therefore, compromising an NSP has only temporary impacts on the system. The validity period can be adjusted flexibly and can offer another level of security-performance trade-off. Note that the delegation can be done periodically (e.g., every day) with no impact on real-time performance, and can also significantly shorten ID revocation lists. Issuing a valid ID (i.e., the public key) is non-interactive and as efficient as the base IBS signature.

In another embodiment of the present disclosure, the PKI Alliance can further incorporate offline execution of key generation. The proposed PKI/PKG Alliance method is suitable for offline-online computation techniques. Offline-online signatures pre-compute message-independent tokens that can speed up online signature generation. In the proposed PKI/PKG Alliance method, the key generation (e.g., as in threshold PKGs with IBS) and some steps of the signature generation that are independent of certificates (e.g., commitment and randomness calculations) can be done offline. This applies to not only Schnorr-based but also NIST-PQC digital signatures. Furthermore, some of the MPC-based threshold techniques naturally admit offline-online processing.

### Example 1

500 CAs were used to form multiple CAAs (PKI Alliances) of an SCMS architecture using FROST, a recently proposed (conventional-secure) threshold signature. Data was collected on a vehicle that traveled across each CAA while receiving certificates via SCMS. The results depicted in Table 1 show that PKI alliances result in a significant reduction in both the traffic and computation overheads that arise from the certificate generation and delivery process.

TABLE 1
Handoff overhead reduction with PKI alliances
over current standard PKI practices.

| | Number of CAAs | | | | | |
|---|---|---|---|---|---|---|
| | 5 | 10 | 25 | 50 | 100 | 125 |
| | CAA size | | | | | |
| | 100 | 50 | 20 | 10 | 5 | 4 |
| Traffic overhead reduction (%) | 98 | 97 | 94 | 89 | 79 | 74 |
| Computation overhead reduction (%) | 21 | 59 | 76 | 79 | 76 | 69 |

As shown in Table 1, reduction in traffic overhead diminishes as the number of CAAs increases. A higher number of CAAs means higher CA handoffs and hence greater traffic overhead. The computation overhead is optimized around a number of CAAs of 50 (CAA size of 10). This is because excessively low or excessively high numbers of CAAs incur high computation due to a large number of CAs involved in the thresholding scheme in the case of low numbers of CAAs (or high numbers of CAs per alliance), and to a large number of handoffs in the case of high numbers of CAAs.

This disclosure presents several implementations and configurations for a cryptographic key alliance (e.g, a PKI alliance, or a SKE alliance) with reference to various exemplary embodiments. As those skilled in the art will readily appreciate, various aspects described throughout this disclosure may be extended to other systems, apparatuses, and modules.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The present disclosure uses the term “coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-4 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-4 may be configured to perform one or more of the methods, features, or steps described herein. The novel frameworks described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged.

What is claimed is:

1. A method for performing a network handoff for a mobile device, comprising:
communicating via a first network operated by a first network provider, wherein the mobile device was authenticated for secure connection with the first network using an umbrella public key;
identifying a second network operated by a second network provider, different from the first network provider;
causing the mobile device to be authenticated for secure connection with the second network using the same umbrella public key; and
communicating via the second network.

2. The method of claim 1, wherein the first network provider and second network provider are members of a certification authority alliance.

3. The method of claim 2, further comprising:
receiving an umbrella certificate based on the umbrella public key prior to establishing secure connection with the first network; and
using the umbrella certificate to cause the mobile device to be authenticated for secure connection with the second network.

4. The method of claim 2, wherein the umbrella key was generated by the certification authority alliance using multi party computation-based thresholding.

5. The method of claim 1, wherein causing the mobile device to be authenticated for secure connection with the second network does not involve generation of a new digital certificate for the second network.

6. The method of claim 1, wherein the mobile device is an automobile.

7. The method of claim 1, wherein the first network and second network are cellular networks having different geographic service areas.

8. A device capable of efficient network handoffs, comprising:
a wireless transceiver configured to communicate with at least one class of wireless network;
a processor connected to the wireless transceiver; and
a memory having software stored thereon which, when executed by the processor, causes the processor to:
establish secure connection with a first wireless network by using an umbrella cryptographic key;
communicate via the first wireless network;
determine that a secure connection to a second wireless network, different from the first wireless network, should be made;
authenticate connection with the second wireless network using the same umbrella cryptographic key; and
communicate via the second wireless network.

9. The device of claim 8, wherein the first wireless network and second wireless network are provided by separate entities conducting digital certificate issuance operations through a common certification authority alliance.

10. The device of claim 9, wherein establishing secure connection with the first wireless network further comprises receiving an umbrella certificate usable for authentication with any network conducting digital certificate issuance through the certification authority alliance.

11. The device of claim 10, wherein the umbrella certificate was generated by multiple certification authorities of the certification authority alliance, using multi-party computation-based thresholding.

12. The device of claim 8, wherein the software does not cause the processor to request a new digital certificate to authenticate connection with the second wireless network.

13. The device of claim 8, wherein the device is a component of an automobile.

14. The device of claim 8, wherein the umbrella cryptographic key is an umbrella symmetric key.

15. A method for authenticating a device on a network comprising the steps of:
receiving a signal at a first certificate authority, the signal containing information regarding the device and being associated with a public key;
determining that the signal includes a request for a digital certificate;
verifying an identity of the device;
communicating information associated with the request to other certificate authorities, the first certificate authority and the other certificate authorities being members of a certificate authority alliance;
generating a digital certificate for authenticating the device via the public key, in collaboration with at least a portion of the other certificate authorities through a threshold signature scheme; and
transmitting the digital certificate to the device.

16. The method of claim 15, wherein the digital certificate is usable to authenticate the device with any of the members of the certificate authority alliance, without requiring use of a new public key or a new certificate signing request.

17. The method of claim 15, wherein the device is an automobile.

18. The method of claim 15, wherein the first certificate authority is operated by a first operator and at least a portion of the other certificate authorities are operated by other operators, the first operator and the other operators being associated with independently-controlled entities.

19. The method of claim 15 wherein generating the digital certificate further comprises performing a secure, multi-party computation-based thresholding.

20. The method of claim 15, wherein generating the digital certificate further comprises performing a FROST custom threshold signing operating.

21. The method of claim 15, wherein generating the digital certificate further comprises performing a custom lattice-based signing operation.
